(19) United States
(12) Patent Application Publication
(10) Pub. No.: US 2024/0386571 A1
(43) Pub. Date: Nov. 21, 2024

(54) Vascular Segmentation and Avoidance Using Imaging

(71) Applicant: Neuralink Corp., Fremont, CA (US)

(72) Inventors: Gilbert I. Montague, Fremont, CA (US); Jose Carlos Gallego Fernández, Barcelona (ES); Jacob M. Hoffman, San Francisco, CA (US); Cenk Oguz Saglam, Union City, CA (US)

(73) Assignee: Neuralink Corp., Fremont, CA (US)

(21) Appl. No.: 18/320,073

(22) Filed: May 18, 2023

(51) Int. Cl. G06T 7/11; G06T 7/00

(52) U.S. Cl. CPC G06T 7/11; G06T 7/0012; G06T 2207/30101

(57) ABSTRACT

A rapid, image processing algorithm for avoiding blood vessels in robotic surgery is disclosed in which a microscopic or other image of a target area is subject to a difference in Gaussians, among other filters, to detect the outlines of vasculature and then segmented. Projections from the borders of each vascular segment are arrayed to determine distances across the blood vessels from different points along the vascular segment. A single diameter is assigned to each vascular segment, and pixels within the segment are associated with the diameter. When a target coordinate is given, any pixel within a certain distance of the coordinate is polled in order to determine if it is part of a blood vessel above a certain size. If it is, then a robotic end effector is halted or redirected.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### BACKGROUND

### 1. Field of the Invention

The present application generally relates to computer aided surgery, including optical surgical navigation systems using image or pattern recognition. Specifically, the application is related to an automated safety stop that recognizes when a blood vessel near the surface of the cortical surface of a brain is about to be punctured.

### 2. Description of the Related Art

Devices exist that can be implanted into biological membranes, such as the brain. In certain instances, the implantable device has a biocompatible substrate with conduits, such as electrodes, for stimulation of neurons and/or recording neuronal signals.

Brain implants require delicate control to securely insert and attach an implant and all of the respective connection points to the brain. Several challenges exist in surgically implanting a brain implant, including but not limited to avoiding vasculature, while also making successful physical and electrical connections into the brain.

International Patent Application Publication No. WO 2016/126340, published Aug. 11,2016, discloses implantable devices that can be implanted into the brain of a subject and used for a variety of purposes. The implantable device can have conduits or electrodes that can record or deliver stimulation, such as light, current, voltage, or drugs.

In certain implementations, and particularly with progression of modern medicine, surgical robots are becoming an assistive tool for implantation procedures. Given the limited access to the brain as well as the complex structure of the brain, computer vision for surgical robots becomes a problem in differentiating the varying layers of the brain as well as discerning shadows that may be cast by surgery tools, portions of the implant, or perhaps even the surgical robot itself.

U.S. Patent Application Publication No. US 2021/0007808 A1, published Jan. 14,2021, discloses an optical coherence tomography (OCT) system that rapidly maps the 3D space of brain or other biological tissue in order to guide a surgical robot. While it can be used to plan robotic needle insertions, the system could conceivably overlook surface vasculature.

Hitting vasculature, i.e., blood vessels, can be detrimental. If an electrode, needle, or surgical tool punctures a blood vessel, then blood may ooze out and obscure the work area, not to mention cause unnecessary trauma to the brain. While robotic surgical systems have limitations in vision and assessing where blood vessels are, human surgeons can overlook surface vasculature too.

FIG. 2, for example, illustrates a targeting map that was created with a photograph of a brain. The scale of the photograph is a little less than 1 centimeter (cm) x 1 cm.

The targeting map includes target points that were manually selected by a surgeon. The target points indicate points on the brain for insertion of electrodes by a needle. One of the considerations for where to locate each point is to avoid vasculature. Even at the scale of the photograph, some of the blood vessels are quite small and can be missed.

The problem for implantation is compounded given underlying background movement of the brain, such as blood flow, heart rate, breathing, and natural brain movement. This goes for not only the brain, but other organs in other parts of the body. That is, even a fast robotic end effector given human-selected target points may have difficulty avoiding vasculature given the tiny features and movement of the organ.

There is a need in the art for a vasculature avoidance system that is robust, works in real time, and is independent from other methods.

### BRIEF SUMMARY

Generally, a robotic surgical system employs an image-guided failsafe system to prevent the puncture of blood vessels by a needle or other end effector. A two-dimensional (2D) image of the targeted tissue site is subject to a difference of Gaussians in order to accentuate vasculature, and then the largest diameter along each individual blood vessel is determined from the 2D image. Pixels within the vessel are labeled based on the diameter. When a target point for needle insertion is selected in the image, the pixels around that point are polled in order to determine whether there is a large blood vessel nearby. If a large, and therefore vulnerable, blood vessel is nearby, then the end effector is halted.

To improve processing speed, only discrete points along a blood vessel contour may be selected, and at those discrete points, only a few angles are projected in order to calculate distances to the opposite blood vessel wall and determine the local blood vessel diameter. Such an algorithm may be able to calculate blood vessels diameters within 30 milliseconds (ms), effectively in real time.

Some embodiments of the invention are related to a computationally rapid method of identifying and avoiding blood vessels in robotic surgery. The method can include receiving a two-dimensional image of biological tissue having visible blood vessels, generating a difference of Gaussians of the image, segmenting, in at least one computer processor, the difference of Gaussians of the image in order to identify a vascular segment, projecting multiple rays from a side of the segment to an opposite side of the segment to determine distances across the segment, selecting a minimum distance from the distances, the minimum distance identified as a local diameter of the vascular segment, and labeling pixels within the vascular segment based on the diameter. The method further includes receiving coordinates in the image to be targeted by a surgical robotic end effector, determining whether any pixel within a predetermined distance of the coordinates is labeled based on the diameter, and halting or redirecting the end effector based on the determining.

The method can include comparing the diameter labeled in a pixel to a predetermined threshold in which the halting or redirecting is based on the diameter being greater than a threshold diameter. It can include determining multiple diameters of the vascular segment, and selecting a maximum of the diameters for the labeling of all of the pixels within the vascular segment.

It can include extracting a green channel of the received image for the generating of the difference of Gaussians of the image, in which the green channel efficiently contrasts red blood vessels from surrounding tissue.

The method can include selecting a point on the side of the segment and determining a direction that is normal to the side of the segment at the point, wherein the rays are projected at a fixed set of angles around the normal. The rays can be projected at a maximum of ±30° or ±45° from the normal direction.

The method can further include thresholding the image using a hue-saturation-value (HSV) filter in order to remove a cast shadow from the end effector. It can further include cropping the image from a larger image, and downsampling the image. The method can be optimized to be executed on the computer processor within 20 milliseconds.

The segmenting can be performed by UNet semantic segmentation, ENet semantic segmentation, or Hessian segmentation.

In some embodiments, a non-transitory computer-readable medium may store computer-executable instructions that, when executed by a processor, cause the processor to perform, and/or to instruct the components of the system to perform, any of the methods described above for guiding robotic surgery or other applications.

### BRIEF DESCRIPTION OF THE DRAWINGS

FIG. 1 illustrates a robotic surgery system according to embodiments.

FIG. 2 illustrates a target map for insertions in a brain in accordance with an embodiment.

FIG. 3 is a two-dimensional image of biological tissue in accordance with an embodiment.

FIG. 4 is the extracted green channel of FIG. 3 in accordance with an embodiment.

FIG. 5 is a difference of Gaussians generated from FIG. 4 in accordance with an embodiment.

FIG. 6 is a black & white result of a threshold filter generated from FIG. 5 in accordance with an embodiment.

FIG. 7 illustrates a blood vessel mask generated from segmenting a close-up image of vascular structure in accordance with an embodiment.

FIG. 8 illustrates a subset of contour boundary points selected from FIG. 7 in accordance with an embodiment.

FIG. 9 illustrates a normal vector calculated for adjacent points in FIG. 8 in accordance with an embodiment.

FIG. 10 illustrates multiple rays flanking the normal vector of FIG. 9 in accordance with an embodiment.

FIG. 11 illustrates the determination of distances across a vessel along the rays of FIG. 10 in accordance with an embodiment.

FIG. 12 illustrates a selection of a minimum distance from the distances across the vessel of FIG. 11 in accordance with an embodiment.

FIG. 13 illustrates determining multiple diameters of the vessel in FIG. 12 along contour boundary points in accordance with an embodiment.

FIG. 14 illustrates selecting a maximum of the diameters for labeling pixels within the vessel of FIG. 13 in accordance with an embodiment.

FIG. 15 illustrates determining diameters for all vascular segments in FIG. 14 and labeling associated pixels in accordance with an embodiment.

FIG. 16 illustrates coordinates and a predetermined distance around them in accordance with an embodiment.

FIG. 17 is a flowchart illustrating a process in accordance with an embodiment.

FIG. 18 illustrates an example computing system for robotic surgery in accordance with an embodiment.

FIG. 19 illustrates example components in a computing system for robotic surgery in accordance with an embodiment.

### DETAILED DESCRIPTION

A fast, image processing-based method is used to evaluate vasculature in tissue and mark areas for avoidance by a needle or other device. It is suitable for real-time use in a robotic surgery system, and it can be independent of other robotic navigation systems. Because it can be entirely image-based, it can be implemented using cameras and computing devices.

An image of tissue, such as a mammalian brain, is downselected/downsampled, then can have a particular color channel extracted, such as the green channel. The resulting image is subject to a difference of Gaussians in order to accentuate minute blood vessels. The image can be upsampled after the difference of Gaussians. The resulting image is subject to a thresholding algorithm. The thresholded image is then subjected to a segmentation algorithm to determine what pixels belong to what segments, here being blood vessels, as well as what pixels are not within any blood vessel. Distances across the (two-dimensional) blood vessels are projected at a set of angles along various points along the segment boundaries, and the minimum distance at each point is selected as the diameter at that point. The pixels within the blood vessel are labeled with the maximum, average, or other appropriate diameter.

When a target coordinate in the image is known, surrounding pixels are polled to determine if any are labeled as belonging to blood vessels greater than a predetermined diameter. If any are, then an end effector is stopped before it touches or pierces the target point.

An “end effector” can include a needle, forceps, robotic hand or grasper, actuator, sensor, or other item located at the end of a robotic arm or other automated manipulator, or as otherwise known in the art.

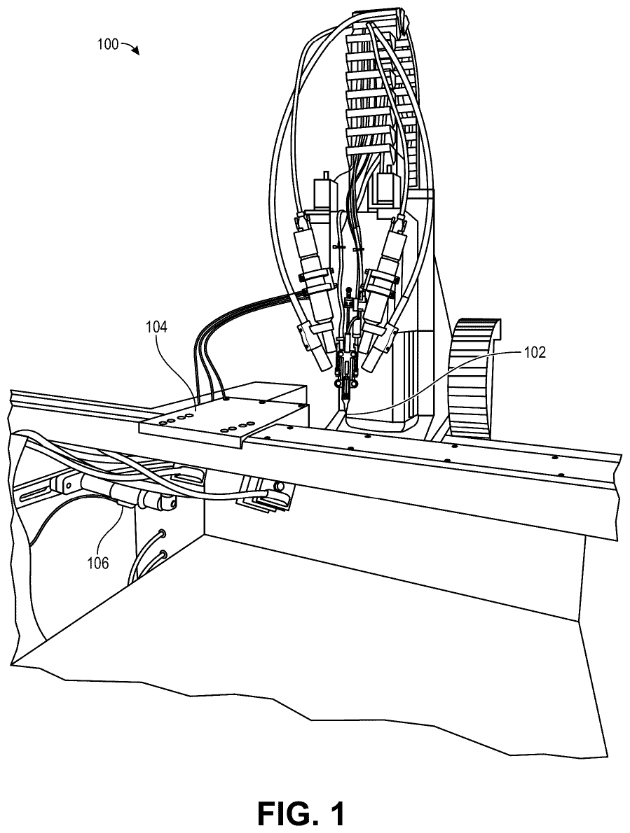

FIG. 1 illustrates an example system 100 for robotic surgical implantation of an electrode device, according to embodiments. In some embodiments, the entire system 100 may be associated with a robot, for example a single robot may be integrated together with all the components of system 100. In some embodiments, some sub-systems of system 100 may be combined, for example a single robot may include an inserter head 102 that can also perform the functions of device engagement sub-system 104.

In this example, system 100 includes an inserter head 102 and device engagement sub-system 104. Device engagement sub-system 104 can engage electrodes for implantation, and inserter head 102 can perform targeting and/or insertion verification functions while implanting the electrodes in neurological tissue, as described herein below. Inserter head 102 may also be referred to as a targeting and/or insertion verification sub-system, and device engagement sub-system 104 may also be referred to as an electrode stage. In some embodiments, the functions of inserter head 102 and device engagement sub-system 104 can instead be performed by a single apparatus. For example, in some embodiments, the functions of device engagement sub-system 104 may be performed by components of inserter head 102. System 100 may further include supporting accessories, such as ultrasonic cleaner 106.

System 100 and/or sub-system 104 can contain light sources configured to illuminate the electrode device, and system 100 and/or sub-system 102 can contain light sources configured to illuminate the surgical field. The light sources illuminating the electrode device or an insertion needle can produce light of wavelengths selected based on a material associated with the electrode device or needle, while the light sources illuminating the surgical field can produce light of wavelengths chosen for imaging the target tissue. In particular, system 100 may contain multiple independent light modules, each capable of independently illuminating with 405 nm, 525 nm, and 650 nm or white light.

System 100 can contain cameras configured to obtain images, such as digital photographs of the electrode device and an insertion needle, and cameras configured to obtain images of the target neurological tissue, e.g. a brain cortex. In another example, the images can include those of any subject relevant to robotic surgical implantation. In a typical embodiment, the cameras can include two cameras arranged at a relative angle (e.g., a relative angle substantially equal to 45°, or some other angle). In various embodiments, system 100 can contain additional cameras or other sensors, such as video cameras, microphones, chemical sensors, temperature sensors, time sensors, and force or pressure sensors, and is not limited by the present disclosure.

The light sources may include one or more light sources that can be cycled or strobed between illuminated and extinguished states, and/or among different wavelengths of light, so that the cameras can image different perspectives or aspects of the surgical field. In an embodiment, the cameras can be cooled in order to increase their sensitivity, such as to faint fluorescent light. In one embodiment, one or more of the cameras may be integrated into a microscope. In embodiments, the light sources may be suitable for interferometry, such as that used in optical coherence tomography.

In embodiments where the light sources are suitable for interferometry, such as that used in optical coherence tomography, a sensor may be used for the interferometry.

System 100 can include a processing unit configured to execute a computer vision heuristic to process the images obtained by the cameras. The computing system may be communicatively coupled to a plurality of cameras configured to image one or more portions of the surgical field and/or the electrode device and needle. In particular, the computing system can apply computer vision techniques to images from the cameras in order to determine the location and/or orientation of the electrode device. In an embodiment, the computing system can determine locations and/or orientations of an insertion needle and a target tissue for implantation. In embodiments, the processing unit may be suitable for processing and extracting surface data. The computing system may then process that data. For example, the computing system can determine a contour of the target surgical tissue, based on images from the cameras. In various embodiments, a processing unit can include one or more processors, one or more processing cores, one or more computing systems, one or more GPUs, or combinations thereof.

System 100 can contain one or more robotic assemblies, such as a robotic assembly configured to implant the electrode device surgically into target biological tissue. The robotic assemblies may be guided by a processing unit based on the triangulated locations of the electrode device, an insertion needle, and/or a target tissue, determined by the computing system. In an embodiment, system 100 can further contain an additional robotic assembly configured to attach an engagement element of the insertion needle to a reciprocal engagement element on the electrode device. In an embodiment, when surgically implanting the electrode device, the robotic assemblies can surgically implant the insertion needle attached to the electrode device. The robotic assemblies can further be guided based on images from the cameras.

In some embodiments, system 100 can include additional cameras, and is not limited by the present disclosure. For example, system 100 can use a separate camera system, located on the head of a robotic assembly, for mapping the target tissue site. In some embodiments, this robotic assembly may also be configured to carry an insertion needle. The separate camera system can be movably situated on one or more axes. In an embodiment, the system drives this robotic assembly down an axis, such that a focus of the camera system is below the target tissue site of interest, such as brain tissue. The robotic assembly can move upward along the axis, and/or scan the camera system upwards, in order to image the target tissue.

In a typical embodiment of the present disclosure, robotic surgery system 100 may implant implantable devices including electrodes with improved depth penetration that are able to penetrate below the surface of biological tissue (e.g., brain cortex). The disclosed robotic system may implant implantable devices that are arranged in a pillbox, a cartridge, and/or a pillbox-cartridge assembly such as those discussed in a U.S. Pat. No. 11,103,695, issued Aug. 31, 2021, titled “Device Implantation Using a Cartridge,” which is hereby incorporated by reference. Additionally, the disclosed robotic system may control the operation of a needle. The location of electrodes may be carefully selected based on physiological, therapeutic, and/or scientific considerations.

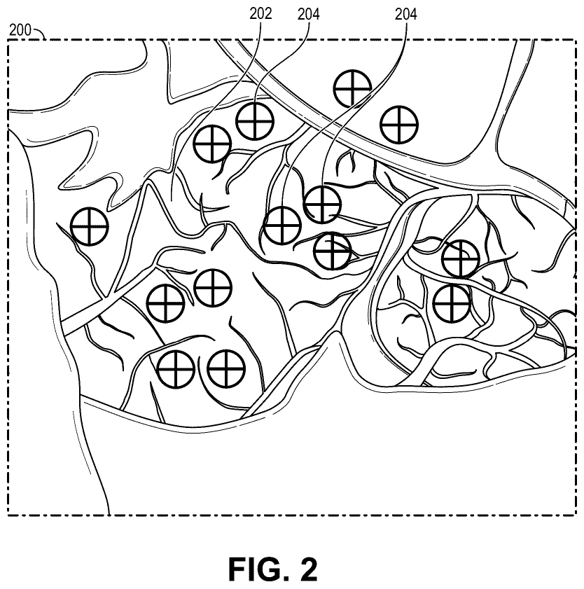

FIG. 2, for example, illustrates targeting map 200 created with a photograph of brain 202. As described above, the targeting map includes target points 204 for electrode insertions that were manually selected by a surgeon. However, they could also be automatically selected by an expert system given proper parameters and rule sets.

Each target point can be zoomed-in upon in order to assess surface vasculature. A camera for such imaging may be mounted on a robotic arm or secured at a relative distance from the surgical site.

“Surface vasculature” includes blood vessels that are at or near the surface of the tissue and visible at the surface, or as otherwise known in the art.

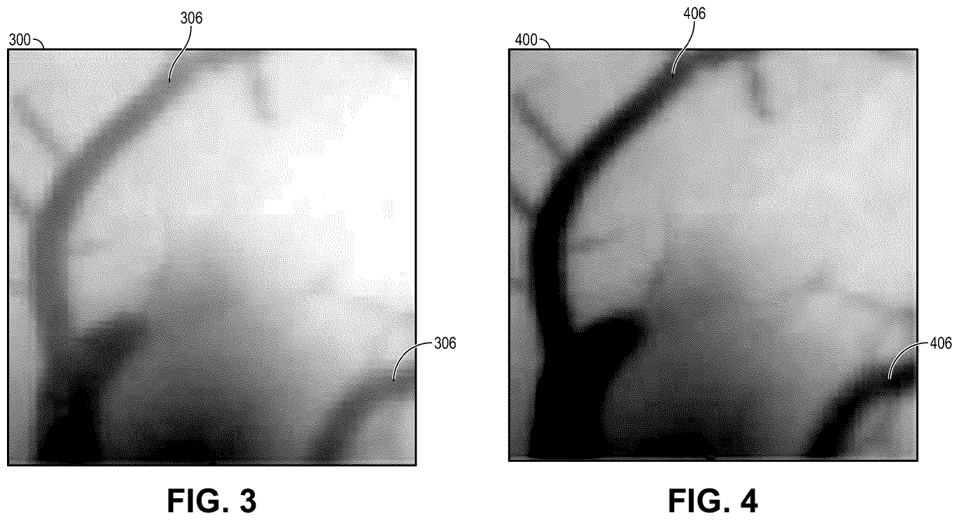

FIG. 3 is a two-dimensional image of biological tissue in accordance with an embodiment. It is a close up of brain tissue and was cropped from a larger view. Two-dimensional image 300 shows multiple blood vessels 306. Even in an original color photograph, distinctions between redish-orange blood vessels 306 and surrounding pinkish-orange tissue is difficult. Barely visible in the bottom middle, a somewhat darker area is a shadow of a needle about to pierce the tissue.

In order to remove the shadow of the needle, or artifacts and shadows from wires and connections, the input image can optionally be subject to a hue-saturation-value (HSV) filter.

In the exemplary embodiment, the image is downsampled such that fewer pixels are used. Downsampling is somewhat a method of blurring a figure, but its intent here is to simplify the image for further steps in processing.

FIG. 4 shows the image of FIG. 3 in which its green channel, of the red-green-blue

channels, has been extracted. Green channel image 400 shows more contrast and detail of the blood vessels than the red or blue channels. For example, blood vessels 406 are more distinguishable from the surrounding yellowish-pink tissue that surrounds them in the previous figure.

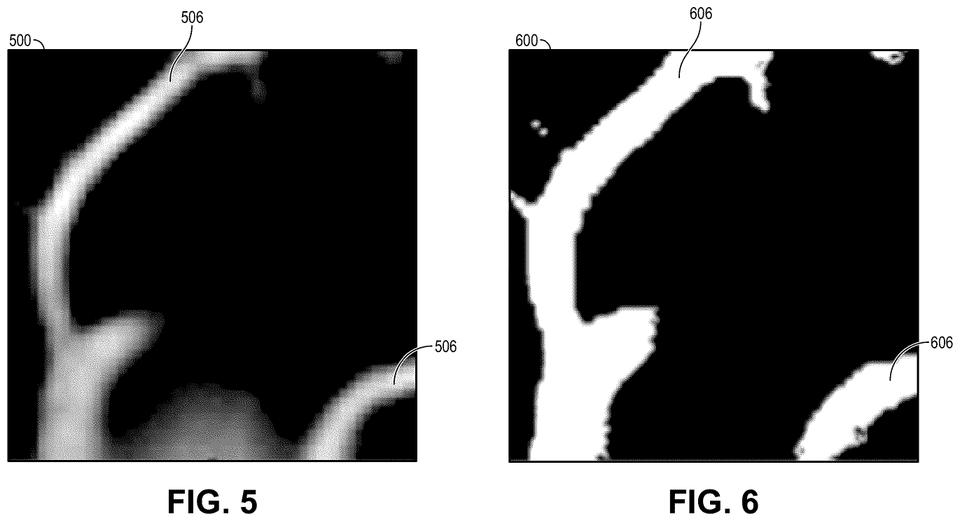

FIG. 5 is the resulting image of a difference of Gaussians generated from FIG. 4. A difference of Gaussians is an algorithm that convolves an image with two, different spatial Gaussian filters, each having different variances. The convolving blurs the images. The difference in Gaussians then subtracts the blurred images to form a resulting image.

Like edge detection, the difference in Gaussians filtering brings out detail in an image. Unlike edge detection, however, it acts like a spatial bandpass filter instead of a high pass filter. This technique can be used with optimized convolution matrices for the scale of blood vessels used. The optimization may involve using Gaussians with widely different variances or similar variances, depending on the feature lengths in the image.

In the embodiment, difference in Gaussians 500 accentuates blood vessels 506 from the surrounding tissue. As a demonstration of its effectiveness, it even shows the needle shadow in the bottom middle.

The difference in Gaussians image can then be upsampled if necessary or preferred for further processing.

FIG. 6 is a black & white image result of FIG. 5 being put through a threshold filter. The filter cuts off (i.e. shows as black) values that are below a certain value and allows (i.e., shows as white) values that are at or above the predetermined value.

The filter turns the grayscale difference of Gaussians image to black & white,

sharpening the difference between blood vessels 606 and their surroundings. At this point, the image is ready for more specialized processing.

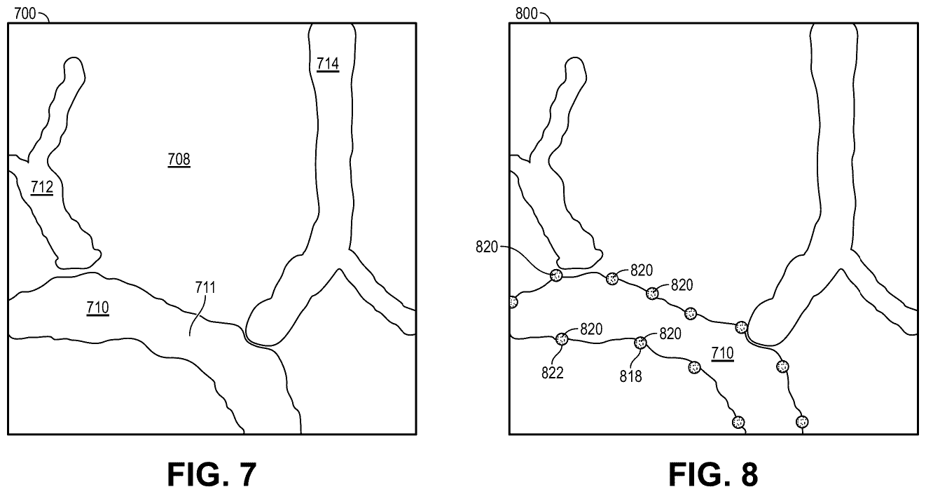

FIG. 7 illustrates blood vessel mask 700 generated from segmenting a close-up image of vascular structure. Several segmentation algorithms are available that identify separate regions in an image and assign pixels to those regions.

Among other algorithms, segmenting in a preferred embodiment can be performed by UNet semantic segmentation, ENet semantic segmentation, Hessian segmentation, or other segmentation algorithms.

During segmentation, each pixel of the image is labeled as either interstitial space 708, i.e., part of no blood vessels, or part of a vessel segment. In the figure, vascular segments 710, 712, and 714 are detected, and their pixels are associated appropriately. For example, pixel 711 is labeled with metadata to associate the pixel with vascular segment 710.

“Labeling” a pixel includes associating, either within an image or external to the image, the pixel with data, such as a segment, value, or other data, or as otherwise known in the art. For example, a separate image mirroring a first image can hold a value in each pixel that corresponds to a pixel in the same position as in the first image.

FIG. 8 illustrates the selection of contour boundary points 820 along vascular segment 710 in image 800. The selected points are a subset of all of the boundary points along the 2D projection of the walls of the blood vessel, with perhaps tens, hundreds, or thousands of pixels in between them.

Contour boundary points 818 and 822 are considered neighboring, adjacent points because they are the closest selected contour boundary points on one side of the vascular segment. Neighboring points may be spaced farther apart (e.g., with thousands of pixels between them) in order to speed processing, or they may be spaced close together (e.g., with tens of pixels between them) in order to achieve higher accuracy.

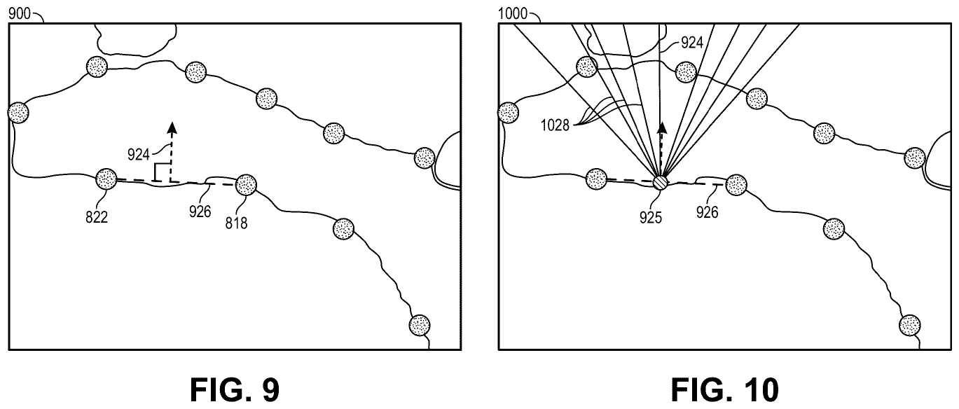

FIG. 9 illustrates a normal vector calculated for adjacent contour boundary points 818 and 822 in image 900. Line segment 926 is formed between contour boundary points 818 and 822. Unit normal vector 924 is perpendicular to line segment 926 and points inward, to the opposite side of the vascular segment. The normal vector can be placed anywhere along the adjacent vector.

FIG. 10 illustrates the projection of multiple rays 1028 from a side of the vascular segment in image 1000 toward the opposite side of the vascular segment.

In the figure, midpoint 925 of line segment 926 is found. Normal vector 924 is placed projecting from midpoint 925. Rays 1028 are also projected from midpoint 925, and the rays project from either side of the normal vector at non-perpendicular angles.

Rays 1028 flank normal vector 924 by predetermined numbers of degrees. These predetermined degrees can be fixed, such as ±0.5°, ±1.0°, ±2.0°, ±3.0°, ±4.0°, ±5.0°, ±6.0°, ±7.0°, =8.0°, ±9.0°, =10.0°, ±12.5°, ±15.0°, ±17.5°, =20.0°, ±22.5°, ±25.0°, ±27.5°, ±30.0°, ±32.5°, ±35.0°, ±37.5°, ±40.0°, ±42.5°, ±45.0°, ±50.0°, ±55.0°, ±60.0°, ±65.0°, ±70.0°, ±75.0°, ±80.0°, and =85.0°. In some embodiments, the rays may only be projected up to a maximum of ±30° or ±45° from the normal direction vector 924.

A technical advantage of selecting a discrete set of rays is that it limits the number of calculations that must be performed to determine the distance to the other side of the vascular segment.

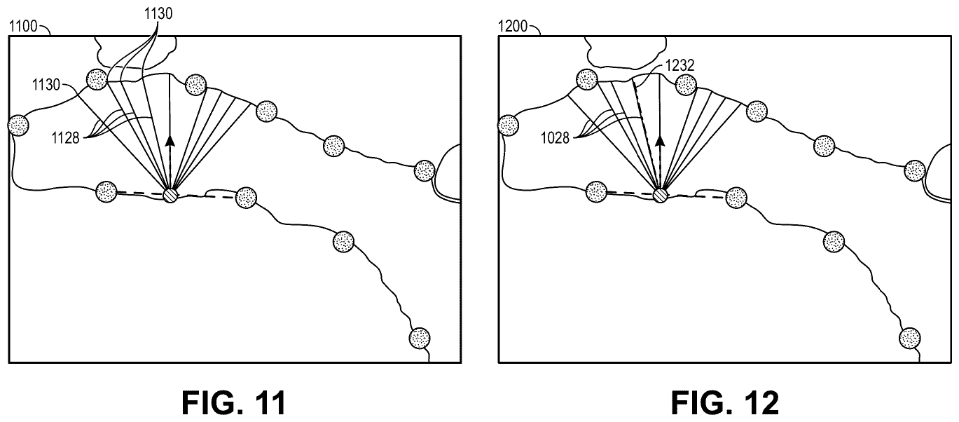

FIG. 11 illustrates the determination of distances across a blood vessel along the rays 1028 from the midpoint of the line segment shown in image 1100. Distances 1130 of the rays are determined by finding where they intersect the opposite side of the vascular segment.

In some instances where there is no intersection, such as at the border of the image, the distance may be calculated as not available.

FIG. 12 illustrates a selection of the minimum distance across the vascular segment of rays 1028 in image 1200. The minimum distance is the shortest, most straight-across route to the opposite side of the blood vessel. As seen in the figure, all longer distances are not the most straight-across route.

This minimum distance is identified as the diameter 1232 of the vascular segment at that midpoint location of the adjacent vector. Although this is a distance calculated from a 2D projection of the vascular segment and thus not an entirely accurate determination of the diameter of the blood vessel, it has been found to be suitable for safety calculations.

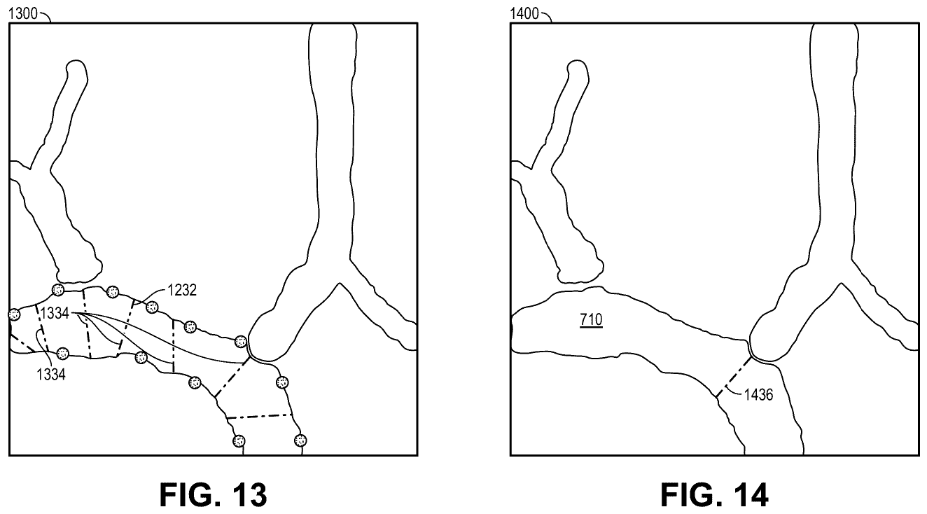

FIG. 13 illustrates determining multiple diameters of the blood vessel along contour boundary points in image 1300. Specifically, diameters 1334 are found between midpoints of line segments between neighboring points along the vessel in the same fashion as diameter 1232.

Diameters 1334 reflect the best calculation of the local diameter of a blood vessel at certain points along its length. From all of these diameters, one diameter is needed in order to label pixels with a simple, single diameter of the blood vessel to which each pixel belongs.

FIG. 14 illustrates selecting maximum diameter 1436, from diameters 1334 shown in FIG. 13, for labeling pixels within blood vessel 710 of image 1400. That is, all of the pixels in vascular segment 710 are labeled as belonging to a blood vessel having diameter 1436.

To a robotic system, that diameter indicates a risk of blood loss if that pixel is punctured by a needle. The larger the diameter, the higher the risk that a lot of blood will be released. The smaller the diameter, the lower the risk.

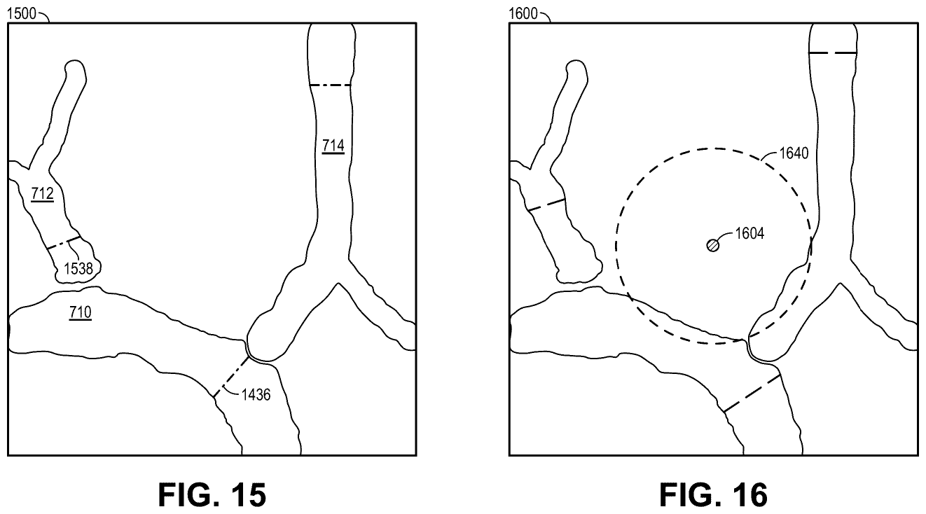

FIG. 15 illustrates the determination of diameters for all vascular segments in image 1500 and their labeling. Besides pixels in vascular segment 710 being labeled with diameter 1436, pixels in vascular segment 712 are labeled with diameter 1538. Pixels in vascular segment 714 are similarly labeled with its calculated diameter.

While certain vascular segments, such as vascular segment 714, include smaller portions that branch from a main part, the smaller parts may be afforded the same diameter as the larger parts because they may have the same risk of blood loss as the larger part.

At this point, pixels in the image are all segmented into vascular segments (or no vascular segment). Their segments, or pixels within the segment, are associated with the single blood vessel diameter calculated for the segment. This annotated image is used to determine whether it is safe to insert a needle or perform some other manipulation at any point in the image.

FIG. 16 illustrates the receipt of coordinates 1604 that are targeted by a surgical robotic end effector. A predetermined distance 1640 around coordinates 1604 is shown, which reflects potential error in positioning the end effector, the diameter of a needle on the end effector, and a safety margin. The predetermined distance may be a radial distance as shown or calculated as a rectangle or square around a central point.

It is now calculated whether any pixels within predetermined distance 1640 of coordinates 1604 are labeled as belonging to a vascular segment having a diameter greater than or equal to a predetermined value. That is, a lookup of the pixel reveals its associated vascular segment, and a lookup table for the vascular segment indicates the blood vessel diameter. If the diameter is greater than or equal to a predetermined value, then an alert is sent to the surgical robot.

In response to the alert, an end effector or a robotic surgical system can be halted from proceeding to its target. It can be parked above the target point to await human intervention or an independent computer assessment. Alternatively, the end effector can be redirected to automatically skip the target and proceed to another target point. A human or computer can determine whether to come back to the target, despite the alert.

In this way, a potentially disruptive piercing of a blood vessel and subsequent bleeding can be avoided.

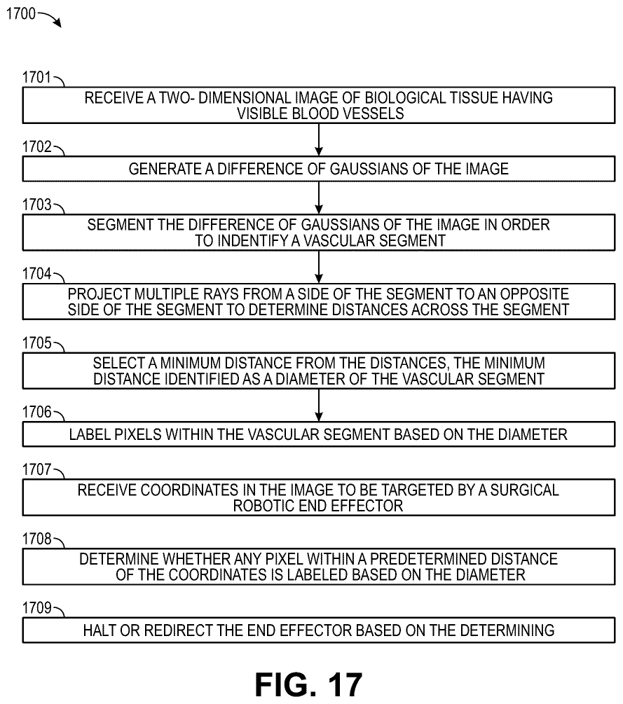

FIG. 17 is a flowchart of a process 1700 in accordance with an embodiment. In operation 1701, a two-dimensional image of biological tissue having visible blood vessels is received. In operation 1702, a difference of Gaussians of the image is generated. In operation 1703, the difference of Gaussians of the image is segmented in order to identify one or more vascular segments. In operation 1704, multiple rays are projected from a side of the segment to an opposite side of the segment in order to determine distances across the segment. In operation 1705, a minimum distance is selected from the distances, the minimum distance identified as a diameter of the vascular segment. In operation 1706, pixels are labeled within the vascular segment based on the diameter.

In operation 1707, coordinates in the image to be targeted by a surgical robotic end effector are received. In operation 1708, it is determined whether any pixel within a predetermined distance of the coordinates is labeled based on the diameter. In operation 1709, the end effector is halted or redirected based on the determining.

An alternative method for avoiding vasculature is also available. In it, the 2-D image is processed up through the black & white threshold algorithm of FIG. 6. The image is then converted to a vessel segmentation mask.

In a first measurement pass, a distance transform and thresholding are applied based on a requested minimum vessel diameter to avoid. The distance transform and thresholding are applied to skeletonize the vessel segmentation mask and remove vessels that do not match the size criteria requested.

A second measurement pass is the applied for avoiding blood vessels with diameters greater than 300 μm and/or avoiding blood vessels with diameters greater than 100 μm. The same distance transform and thresholding is applied to expand the blood vessels that match the size criteria back to their real world positions in the camera frame.

Using the resulting measured vasculature mask, a target location is projected onto the mask. If any blood vessel pixels are located within a radius of the target location, then the robotic arm is ordered to abort the insertion. Small radiuses, which imply precisely located coordinates or coordinates for which more risk is acceptable, will encompass few blood vessels than larger radiuses.

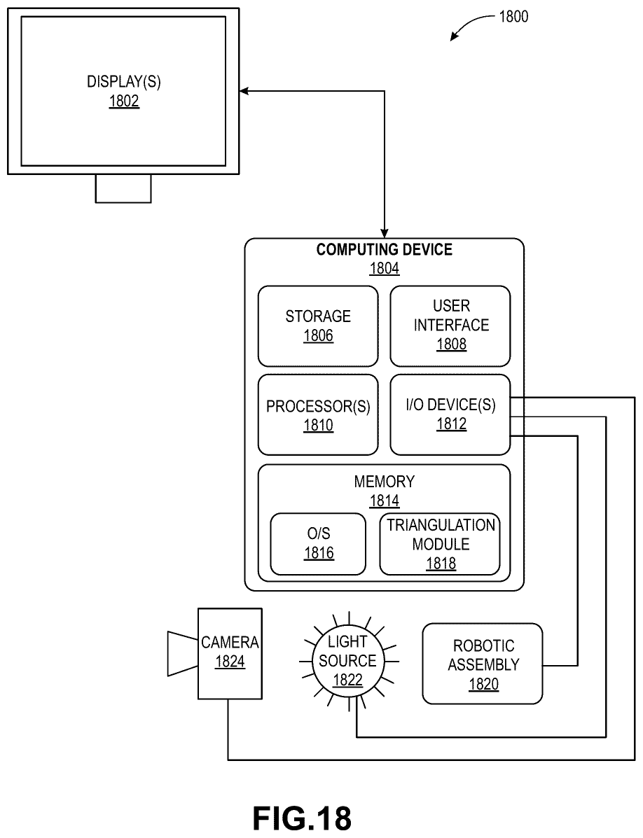

FIG. 18 illustrates components of an example computing system 1800, according at least one example. Computing system 1800 can include one or more display devices such as display devices 1802. The display devices 1802 may be any suitable devices capable of visually presenting information. Examples of such devices may include cathode ray tube (CRT) displays, light-emitting diode (LED) displays, electroluminescent displays (ELD), electronic paper, plasma display panels (PDP), liquid crystal displays (LCD), organic light-emitting diode (OLED) displays, surface-conduction electron-emitter displays (SED), field emission displays (FED), projectors (LCD, CRT, digital light processing (DLP), liquid crystal on silicon (LCoS), LED, hybrid LED, laser diode), and any other suitable device capable of displaying information.

Computing system 1800 may include computing device 1804, which may be connected to robotic assembly 1820, light source 1822, and camera 1824, as well as to any other devices, such as actuators, etc. The computing device 1804 may be in communication with these devices and/or other components of the robotic surgery system via one or more network(s), wired connections, and the like. The network may include any one or a combination of many different types of networks, such as cable networks, the Internet, wireless networks, cellular networks, radio networks, and other private and/or public networks.

Turning now to the details of the computing device 1804, the computing device 1804 may include at least one memory 1814 and one or more processing units (or processor(s)) 1810. The processor(s) 1810 may be implemented as appropriate in hardware, computer-executable instructions, software, firmware, or combinations thereof. For example, the processor(s) 1810 may include one or more general purpose computers, dedicated microprocessors, or other processing devices capable of communicating electronic information. Examples of the processor(s) 1810 include one or more application-specific integrated circuits (ASICs), field programmable gate arrays (FPGAs), digital signal processors (DSPs) and any other suitable specific or general purpose processors.

Computer-executable instruction, software, or firmware implementations of the processor(s) 1810 may include computer-executable or machine-executable instructions written in any suitable programming language to perform the various functions described. The memory 1814 may include more than one memory and may be distributed throughout the computing device 1804. The memory 1814 may store program instructions (e.g., a triangulation module 1818) that are loadable and executable on the processor(s) 1810, as well as data generated during the execution of these programs. Depending on the configuration and type of memory including the triangulation module 1818, the memory 1814 may be volatile (such as random access memory (RAM)) and/or non-volatile (such as read-only memory (ROM), flash memory, or other memory). In an embodiment, the triangulation module 1818 may receive and/or adjust the linear combination coefficients for Laplacian estimation based on measured potentials. In an embodiment, triangulation module 1818 may implement the linear combination based on these coefficients. The computing device 1804 may also include additional removable and/or non-removable storage 1806 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 1814 may include multiple different types of memory, such as static random access memory (SRAM), dynamic random access memory (DRAM), or ROM. The memory 1814 may also include an operating system 1816.

The memory 1814 and the additional storage 1806, both removable and non-removable, are examples of computer-readable storage media. For example, computer-readable storage media may include volatile or non-volatile, removable, or non-removable media implemented in any suitable method or technology for storage of information such as computer-readable instructions, data structures, program modules, or other data. As used herein, modules may refer to programming modules executed by computing systems (e.g., processors) that are part of the triangulation module 1818. The modules of the triangulation module 1818 may include one or more components, modules, and the like. For example, triangulation module 1818 may include modules or components that triangulate the location of objects such as electrodes, insertion needles, and/or target tissue based on computer vision. The computing device 1804 may also include input/output (“I/O”) device(s) and/or ports 1812, such as for enabling connection with a keyboard, a mouse, a pen, a voice input device, a touch input device, a display, speakers, a printer, or other I/O device. The I/O device(s) 1812 may enable communication with the other systems of the robotic surgery system.

The computing device 1804 may include a user interface 1808. The user interface 1808 may be used by an operator or other authorized user such as the user to access portions of the computing device 1804 (e.g., the triangulation module 1818). In some examples, the user interface 1808 may include a graphical user interface, web-based applications, programmatic interfaces such as application programming interfaces (APIs), or other user interface configurations.

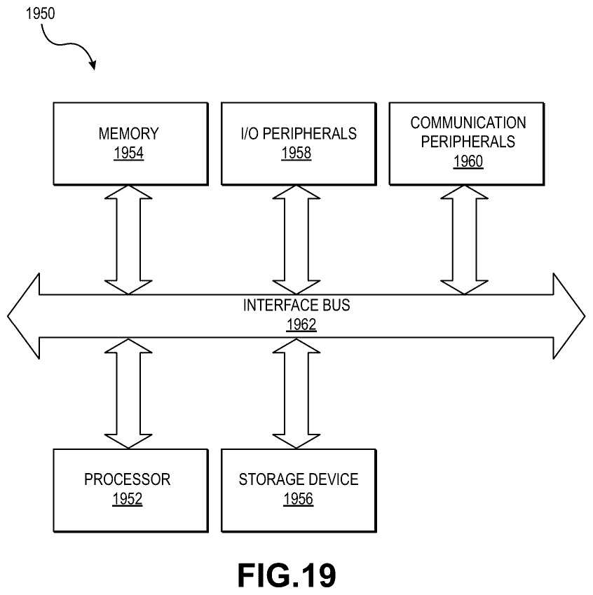

FIG. 19 illustrates examples of components of a computer system 1950, according to at least one example. The computer system 1950 may be a single computer such as a user computing device and/or can represent a distributed computing system such as one or more server computing devices.

The computer system 1950 may include at least a processor 1952, a memory 1954, a storage device 1956, input/output peripherals (I/O) 1958, communication peripherals 1960, and an interface bus 1962. The interface bus 1962 is configured to communicate, transmit, and transfer data, controls, and commands among the various components of the computer system 1950. The memory 1954 and the storage device 1956 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 1954 and the storage device 1956 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 1950.

Further, the memory 1954 includes an operating system, programs, and applications. The processor 1952 is configured to execute the stored instructions and includes, for example, a logical processing unit, a microprocessor, a digital signal processor, and other processors. The memory 1954 and/or the processor 1952 can be virtualized and can be hosted within another computing system of, for example, a cloud network or a data center. The I/O peripherals 1958 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 1958 are connected to the processor 1952 through any of the ports coupled to the interface bus 1962. The communication peripherals 1960 are configured to facilitate communication between the computer system 1950 and other computing devices over a communications network and include, for example, a network interface controller, modem, wireless and wired interface cards, antenna, and other communication peripherals.

The terms “computing system” and “processing unit” as used herein are intended for all purposes to be interpreted broadly and is defined for all uses, all devices, and/or all systems and/or systems in this disclosure as a device comprising at least a central processing unit, a communications device for interfacing with a data network, transitory computer-readable memory, and/or a non-transitory computer-readable memory and/or media. The central processing unit carries out the instructions of one or more computer programs stored in the non-transitory computer-readable memory and/or media by performing arithmetical, logical, and input/output operations to accomplish in whole or in part one or more steps of any method described herein. A computing system is usable by one or more users, other computing systems directly and/or indirectly, actively and/or passively for one or more suitable functions herein. The computing system may be embodied as a computer, a laptop, a tablet computer, a smartphone, and/or any other suitable device and may also be a networked computing system, a server, or the like. Where beneficial, a computing system can include one or more human input devices such as a computer mouse and/or keyboard and one or more human interaction device such as one or more monitors. A computing system may refer to any input, output, and/or calculating device associated with providing an experience to one or more users. Although one computing system may be shown and/or described, multiple computing systems may be used. Conversely, where multiple computing systems are shown and/or described, a single computing device may be used.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

In some embodiments, the systems and methods of the present disclosure can be used in connection with neurosurgical techniques. However, one skilled in the art would recognize that neurosurgical techniques are a non-limiting application, and the systems and methods of the present disclosure can be used in connection with any biological tissue. Biological tissue can include, but is not limited to, the brain, muscle, liver, pancreas, spleen, kidney, bladder, intestine, heart, stomach, skin, colon, and the like.

The systems and methods of the present disclosure can be used on any suitable multicellular organism including, but not limited to, invertebrates, vertebrates, fish, bird, mammals, rodents (e.g., mice, rats), ungulates, cows, sheep, pigs, horses, non-human primates, and humans. Moreover, biological tissue can be ex vivo (e.g., tissue explant), or in vivo (e.g., the method is a surgical procedure performed on a patient).

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples; alternative implementations may employ differing values or ranges, and can accommodate various increments and gradients of values within and at the boundaries of such ranges.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

What is claimed is:

1. A computationally rapid method of identifying and avoiding blood vessels in robotic surgery, the method comprising:
receiving a two-dimensional image of biological tissue having visible blood vessels;
generating a difference of Gaussians of the image;
segmenting, in at least one computer processor, the difference of Gaussians of the image in order to identify a vascular segment;
projecting multiple rays from a side of the segment to an opposite side of the segment to determine distances across the segment;
selecting a minimum distance from the distances, the minimum distance identified as a local diameter of the vascular segment;
labeling pixels within the vascular segment based on the diameter;
receiving coordinates in the image to be targeted by a surgical robotic end effector;
determining whether any pixel within a predetermined distance of the coordinates is labeled based on the diameter; and
halting or redirecting the end effector based on the determining.

2. The method of claim 1 further comprising:
comparing the diameter labeled in a pixel to a predetermined threshold,
wherein the halting or redirecting is based on the diameter being greater than a threshold diameter.

3. The method of claim 1 further comprising:
determining multiple diameters of the vascular segment; and
selecting a maximum of the diameters for the labeling of all of the pixels within the vascular segment.

4. The method of claim 1 further comprising:
extracting a green channel of the received image for the generating of the difference of Gaussians of the image,
whereby the green channel efficiently contrasts red blood vessels from 5 surrounding tissue.

5. The method of claim 1 further comprising:
selecting a point on the side of the segment; and
determining a direction that is normal to the side of the segment at the point, wherein the rays are projected at a fixed set of angles around the normal.

6. The method of claim 1 wherein the rays are projected at a maximum of ±30° or ±45° from the normal direction.

7. The method of claim 1 further comprising:
thresholding the image using a hue-saturation-value (HSV) filter in order to remove a cast shadow from the end effector.

8. The method of claim 1 further comprising:
cropping the image from a larger image; and
downsampling the image.

9. The method of claim 1 wherein method is optimized to be executed on the 2 computer processor within 20 milliseconds.

10. The method of claim 1 wherein the segmenting is performed by UNet semantic segmentation, ENet semantic segmentation, or Hessian segmentation.

11. A machine-readable non-transitory medium embodying information indicative of instructions for a computationally rapid method of identifying and avoiding blood vessels in robotic surgery, the information indicative of instructions for causing one or more machines to perform operations comprising:
receiving a two-dimensional image of biological tissue having visible blood vessels;
generating a difference of Gaussians of the image;
segmenting, in at least one computer processor, the difference of Gaussians of the image in order to identify a vascular segment;
projecting multiple rays from a side of the segment to an opposite side of the segment to determine distances across the segment;
selecting a minimum distance from the distances, the minimum distance identified as a local diameter of the vascular segment;
labeling pixels within the vascular segment based on the diameter;
receiving coordinates in the image to be targeted by a surgical robotic end effector;
determining whether any pixel within a predetermined distance of the coordinates is labeled based on the diameter; and
halting or redirecting the end effector based on the determining.

12. The medium of claim 11 wherein the operations are further comprising:
comparing the diameter labeled in a pixel to a predetermined threshold, wherein the halting or redirecting is based on the diameter being greater than a threshold diameter.

13. The medium of claim 11 wherein the operations are further comprising:
determining multiple diameters of the vascular segment; and
selecting a maximum of the diameters for the labeling of all of the pixels within the vascular segment.

14. The medium of claim 11 wherein the operations are further comprising:
extracting a green channel of the received image for the generating of the difference of Gaussians of the image,
whereby the green channel efficiently contrasts red blood vessels from surrounding tissue.

15. The medium of claim 11 wherein the operations are further comprising:
selecting a point on the side of the segment; and
determining a direction that is normal to the side of the segment at the point,
wherein the rays are projected at a fixed set of angles around the normal.

16. A computer system executing program code for a computationally rapid method of identifying and avoiding blood vessels in robotic surgery, the computer system comprising:
a memory; and
at least one processor operatively coupled with the memory and executing program code from the memory comprising instructions for:
receiving a two-dimensional image of biological tissue having visible blood vessels;
generating a difference of Gaussians of the image;
segmenting the difference of Gaussians of the image in order to identify a vascular segment;
projecting multiple rays from a side of the segment to an opposite side of the segment to determine distances across the segment;
selecting a minimum distance from the distances, the minimum distance identified as a local diameter of the vascular segment;
labeling pixels within the vascular segment based on the diameter;
receiving coordinates in the image to be targeted by a surgical robotic end effector;
determining whether any pixel within a predetermined distance of the coordinates is labeled based on the diameter; and
halting or redirecting the end effector based on the determining.

17. The system of claim 16 wherein the operations are further comprising:
comparing the diameter labeled in a pixel to a predetermined threshold,
wherein the halting or redirecting is based on the diameter being greater than a threshold diameter.

18. The system of claim 16 wherein the operations are further comprising:
determining multiple diameters of the vascular segment; and
selecting a maximum of the diameters for the labeling of all of the pixels within the vascular segment.

19. The system of claim 16 wherein the operations are further comprising:
extracting a green channel of the received image for the generating of the 2 difference of Gaussians of the image,
whereby the green channel efficiently contrasts red blood vessels from surrounding tissue.

20. The system of claim 16 wherein the operations are further comprising:
selecting a point on the side of the segment; and
determining a direction that is normal to the side of the segment at the point,
wherein the rays are projected at a fixed set of angles around the normal.
